(19) United States
(12) Patent Application Publication
(10) Pub. No.: US 2025/0104086 A1
(43) Pub. Date: Mar. 27, 2025

(54) SYSTEMS AND METHODS RELATING TO OBJECT PROTECTION

(71) Applicant: Capital One Services, LLC, McLean, VA (US)

(72) Inventors: Jeremy GOODSITT, Champaign, IL (US); Galen RAFFERTY, Mahomet, IL (US); Samuel SHARPE, Cambridge, MA (US); Anh TRUONG, Round Rock, TX (US); Brian BARR, Schenectady, NY (US); Grant EDEN, San Francisco, CA (US); Austin WALTERS, Columbia, TN (US)

(73) Assignee: Capital One Services, LLC, McLean, VA (US)

(21) Appl. No.: 18/473,794

(22) Filed: Sep. 25, 2023

(51) Int. Cl. G06Q 30/012; G06F 11/34; H04L 67/50

(52) U.S. Cl. CPC G06Q 30/012; G06F 11/3438; H04L 67/535

(57) ABSTRACT

A method for object protection identification is provided. The method may: monitor, using a processor, at least one of audio data or history data associated with a user; detect an object replacement triggering event, based on a result of the monitoring; receive user data for a user associated with the at least one of audio data or history data; identify an object corresponding to the object replacement triggering event based on the user data; identify object-related information, the object-related information including at least one of an object protection information or an object replacement information; and transmit the at least one of the object protection information or the object replacement information based on identifying the object-related information.

### TECHNICAL FIELD

Various embodiments of this disclosure relate generally to machine-learning-based techniques for object protection indications, and, more particularly, to systems and methods for tracking and managing protection for user devices and other objects.

### BACKGROUND

Object protection provide users with a level of protection against defects, malfunctions, or other issues that may arise during the life of the object. These protections (e.g., warranties) are typically offered by manufacturers, retailers, or third-party providers and may cover various aspects of the object, such as parts, labor, or replacement of the object in case of failure or other events. However, the management and tracking of these protections can be a complex and cumbersome task for users, often leading to missed opportunities for claiming benefits or being unaware of the protection status of their objects.

Conventionally, users are often responsible for manually tracking and managing such protections, which may involve keeping physical copies of protection documents or inputting protection information into a digital storage system. This manual approach can be time-consuming and error-prone, resulting in misplaced documents, forgotten expiration dates, or incorrect information. Additionally, users may not be aware of the full extent of their coverage, leading to confusion and frustration when attempting to claim protection benefits. Additionally, such practices may not be conducted in real-time and therefore fail to provide relevant information in a digestible manner.

This disclosure is directed to addressing above-referenced challenges. The background description provided herein is for the purpose of generally presenting the context of the disclosure. Unless otherwise indicated herein, the materials described in this section are not prior art to the claims in this application and are not admitted to be prior art, or suggestions of the prior art, by inclusion in this section.

### SUMMARY OF THE DISCLOSURE

According to certain aspects of the disclosure, methods and systems are disclosed for objection protection indication.

In some aspects, the techniques described herein relate to a computer-implemented method for providing an object protection indicator. The method may include: monitoring, using a processor, at least one of audio data or history data associated with a user; detecting an object replacement triggering event, based on a result of the monitoring; receiving user data for a user associated with the at least one of audio data or history data; identifying an object corresponding to the object replacement triggering event based on the user data; identifying object-related information, the object-related information including at least one of an object protection information or an object replacement information; and transmitting the at least one of the object protection information or the object replacement information based on identifying the object-related information.

In some aspects, the techniques described herein relate to a computer-implemented method for offering a safeguarding indicator for an item. The method may include: receiving, from a data server, authentication data related to a user; determining, based on the authentication data, that one or more objects should have replacement coverage; prompting the user via a user device, to obtain and input replacement coverage information corresponding to each of the one or more objects; monitoring, using a processor, at least one of audio data or history data associated with the user; detecting an object replacement triggering event, based on a result of the monitoring; receiving user data for the user associated with the at least one of audio data or history data; identifying object-related information, the object-related information including at least one of object protection information or object replacement information; and transmitting the at least one of object protection information or object replacement information based on identifying the object-related information.

In some aspects, the techniques described herein relate to a system for providing an object protection indicator, the system including: monitoring, using a processor, at least one of audio data or history data associated with a user; detecting an object replacement triggering event, based on a result of the monitoring; receiving user data for a user associated with the at least one of audio data or history data; identifying an object corresponding to the object replacement triggering event based on the user data; identifying object-related information, the object-related information including at least one of object protection information or object replacement information; and transmitting the at least one of object protection information or object replacement information based on identifying the object-related information.

It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1A depicts an exemplary environment for training and/or using a machine-learning model for object protection indication, according to some embodiments of the disclosure.

FIG. 1B depicts an exemplary protection indication system, according to some embodiments of the disclosure.

FIG. 1C depicts an exemplary machine-learning module, according to some embodiments of the disclosure.

FIG. 2 illustrates an exemplary process for objection protection indication, according to some embodiments of the disclosure.

FIG. 3 shows an exemplary machine-learning training flow chart, according to some embodiments of the disclosure.

FIG. 4 is a functional block diagram of a computer, according to exemplary embodiments of the present disclosure.

### DETAILED DESCRIPTION OF EMBODIMENTS

According to certain aspects of the disclosure, methods and systems are disclosed for object protection indication, e.g., warranty notification. The present disclosure relates to a system and method for tracking and managing object warranties, and alleviating manual, time-consuming, and error-prone warranty tracking by users. Existing solutions may not capture valuable information from users' daily interactions about their devices or objects experiencing performance issues, nor provide comprehensive or accurate information about warranty coverage. The present disclosure offers a comprehensive, accurate, and user-friendly solution for managing warranties, incorporating real-time monitoring and notifications related to warranty status and coverage, and utilizing user interactions and information related to objects' performance to assist users in managing their warranties and identifying potential warranty claims.

As will be discussed in more detail below, in various embodiments, systems and methods are described for using machine-learning techniques for object protection identification. By training a machine-learning model, e.g., via supervised or semi-supervised learning, to learn associations between user data, such as audio data, and identification and existence of object protections, the trained machine-learning model may be usable to accurately identify object protections.

Reference to any particular activity is provided in this disclosure only for convenience and not intended to limit the disclosure. A person of ordinary skill in the art would recognize that the concepts underlying the disclosed devices and methods may be utilized in any suitable activity. The disclosure may be understood with reference to the following description and the appended drawings, wherein like elements are referred to with the same reference numerals.

The terminology used below may be interpreted in its broadest reasonable manner, even though it is being used in conjunction with a detailed description of certain specific examples of the present disclosure. Indeed, certain terms may even be emphasized below; however, any terminology intended to be interpreted in any restricted manner will be overtly and specifically defined as such in this Detailed Description section. Both the foregoing general description and the following detailed description are exemplary and explanatory only and are not restrictive of the features, as claimed.

In this disclosure, the term “based on” means “based at least in part on.” The singular forms “a,” “an,” and “the” include plural referents unless the context dictates otherwise. The term “exemplary” is used in the sense of “example” rather than “ideal.” The terms “comprises,” “comprising,” “includes,” “including,” or other variations thereof, are intended to cover a non-exclusive inclusion such that a process, method, or product that comprises a list of elements does not necessarily include only those elements, but may include other elements not expressly listed or inherent to such a process, method, article, or apparatus. The term “or” is used disjunctively, such that “at least one of A or B” includes, (A), (B), (A and A), (A and B), etc. Relative terms, such as, “substantially,” “approximately,” and “generally,” are used to indicate a possible variation of ±10% of a stated or understood value.

It will also be understood that, although the terms first, second, third, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

Terms like “provider,” “merchant,” “vendor,” or the like generally encompass an entity or person involved in providing, selling, and/or renting items to persons such as a seller, dealer, renter, merchant, vendor, or the like, as well as an agent or intermediary of such an entity or person. An “item” or “object” generally encompasses a good, service, or the like having ownership or other rights that may be transferred. As used herein, terms like “user” or “customer” generally encompasses any person or entity that may desire information, resolution of an issue, purchase of a product, or engage in any other type of interaction with a provider. The term “browser extension” may be used interchangeably with other terms like “program,” “electronic application,” or the like, and generally encompasses software that is configured to interact with, modify, override, supplement, or operate in conjunction with other software.

As used herein, a “machine-learning model” generally encompasses instructions, data, and/or a model configured to receive input, and apply one or more of a weight, bias, classification, or analysis on the input to generate an output. The output may include, for example, a classification of the input, an analysis based on the input, a design, process, prediction, or recommendation associated with the input, or any other suitable type of output. A machine-learning model is generally trained using training data, e.g., experiential data and/or samples of input data, which are fed into the model in order to establish, tune, or modify one or more aspects of the model, e.g., the weights, biases, criteria for forming classifications or clusters, or the like. Aspects of a machine-learning model may operate on an input linearly, in parallel, via a network (e.g., a neural network), or via any suitable configuration.

The execution of the machine-learning model may include deployment of one or more machine-learning techniques, such as linear regression, logistical regression, random forest, gradient boosted machine (GBM), deep learning, and/or a deep neural network. Supervised and/or unsupervised training may be employed. For example, supervised learning may include providing training data and labels corresponding to the training data, e.g., as ground truth. Unsupervised approaches may include clustering, classification or the like. K-means clustering or K-Nearest Neighbors may also be used, which may be supervised or unsupervised. Combinations of K-Nearest Neighbors and an unsupervised cluster technique may also be used. Any suitable type of training may be used, e.g., stochastic, gradient boosted, random seeded, recursive, epoch or batch-based, etc.

In an exemplary use case, a computer-based process to provide an object protection indicator by monitoring a user's audio or history data is provided. The method detects an event that triggers object replacement and gathers user data related to the event, such as audio data and warranty data. It then identifies the object and its related information, including protection and replacement details. Finally, the system transmits this information, helping users manage their object's warranty and replacement options more efficiently.

The present disclosure addresses various technical problems presently associated with warranty identification and tracking. One technical problem addressed by this invention pertains to hardware and data recognition. Traditional systems have difficulty accurately discerning and identifying the specific objects at the subject of user complaints, especially when these complaints are made verbally or in unstructured data formats. This can be due to limitations in hardware capacity or software design to process and interpret unstructured audio data. This disclosure's method of monitoring audio data and history data, and subsequently identifying the object of concern based on user data, provides a technical solution to this hardware and data recognition problem. In some embodiments, the use of multiple sources of data and multiple sources of audio data in conjunction with one another serves as an additional solution to the technical problem.

Traditional systems may process audio data from singular or limited sources, which can restrict the scope and accuracy of object identification and user complaint monitoring. Moreover, the sources of data may be less specific to a particular user, e.g., the data may be limited to warranty data registered at the time of purchase. The present disclosure incorporates technical improvements by enabling the system to process and analyze audio data from multiple sources. This may include various user devices like smartphones, smart home devices, wearable technology, or even social media voice clips. The system's ability to consolidate and interpret this diverse range of audio data provides a more comprehensive and accurate understanding of user complaints.

Traditional systems lack the technological sophistication to track warranties effectively and notify users about their availability when needed. The hardware and software required to maintain an accurate, up-to-date database of warranties, associate them with the correct users and products, and trigger notifications at the appropriate times are significant technical challenges. This invention provides a technical solution by identifying object-related information, including warranties, and transmitting this information to the user.

In an exemplary use case, an individual, User A, owns a smart home system comprising a smart refrigerator, a smart speaker, and a smartphone. These devices are interconnected via an Internet of Things (IoT) network and are configured to exchange data with each other and a central server. In operation, the smart speaker, equipped with a microphone, captures ambient audio data in the environment. On a particular day, User A expresses frustration about the malfunctioning smart refrigerator in a conversation within the smart speaker's hearing range. The smart speaker, using a processor, monitors this audio data and identifies it as a potential object replacement triggering event. Additionally, User A posts a complaint about the refrigerator on a social media platform using his smartphone. The system retrieves this data, which is part of the user's history data. The processor analyzes both the audio data and the history data, identifying the smart refrigerator as the object of concern. Subsequently, the system accesses User A's purchase history data from the central server. This data includes information about User A's appliances and their corresponding warranties. It identifies that the smart refrigerator has an active warranty, which qualifies as object protection information. Upon identifying the warranty, the system initiates a notification process. It formulates a message that includes details about the refrigerator's warranty and potential steps for repair or replacement. This message is then transmitted to User A's smartphone and may also be read aloud by the smart speaker.

This example demonstrates a technical improvement in an IoT environment. It effectively leverages multiple hardware devices, sophisticated data processing techniques, and complex algorithms to provide a technical solution to a common problem. This represents a significant technological advancement in the field of smart home systems, IoT networks, and warranty claim tracking and surfacing.

While the examples above involve object protection identification, it should be understood that techniques according to this disclosure may be adapted to any suitable type of data suitable for protection identification. It should also be understood that the examples above are illustrative only. The techniques and technologies of this disclosure may be adapted to any suitable activity.

Presented below are various aspects of machine-learning techniques that may be adapted to object protection identification. As will be discussed in more detail below, machine-learning techniques adapted to object protection identification based on audio and/or financial data may include one or more aspects according to this disclosure, e.g., a particular selection of training data, a particular training process for the machine-learning model, operation of a particular device suitable for use with the trained machine-learning model, operation of the machine-learning model in conjunction with particular data, modification of such particular data by the machine-learning model, etc., and/or other aspects that may be apparent to one of ordinary skill in the art based on this disclosure.

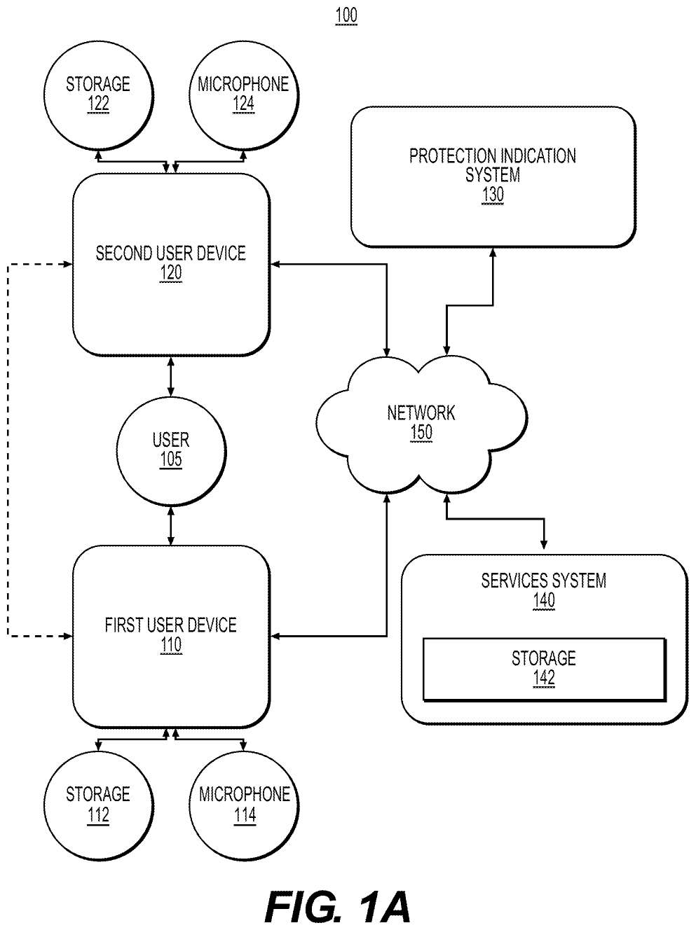

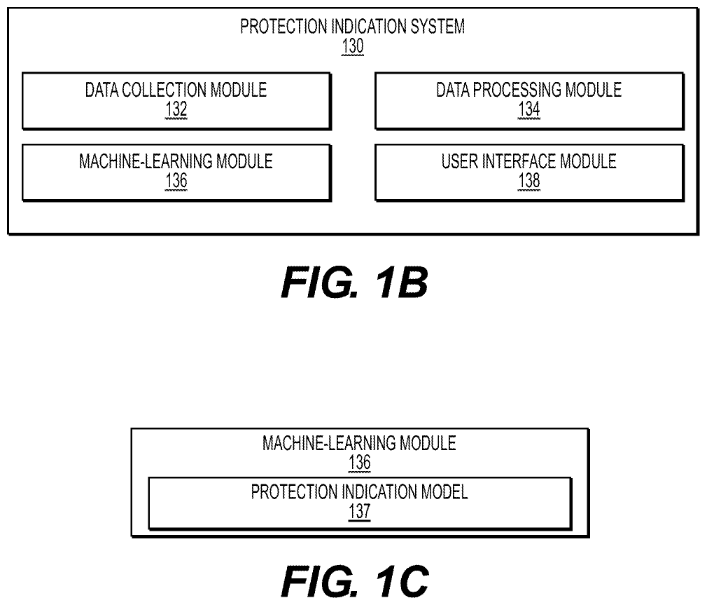

FIG. 1A depicts an exemplary environment 100 that may be utilized with techniques presented herein. Environment 100 may include a first user device 110, a second user device 120, a protection indication system 130, a services (e.g., financial services) system 140, and a network 150. One or more first user device(s) 110, second user device(s) 120, protection indication system 130, services system 140, or the like, may communicate across the electronic network 150. As will be discussed in further detail below, the protection indication system 130 may communicate with one or more of the other components of the environment 100 across electronic network 150. The first user device 110 and second user device 120 may be associated with a user 105, e.g., a user associated with one or more objects which may fall under warranty protection.

In some embodiments, the components of the environment 100 are associated with a common entity, e.g., a financial institution, transaction processor, merchant, or the like. In some embodiments, one or more of the components of the environment is associated with a different entity than another. The systems and devices of the environment 100 may communicate in any arrangement. As will be discussed herein, systems and/or devices of the environment 100 may communicate in order to one or more of generate, train, or use a machine-learning model for object protection indication, among other activities.

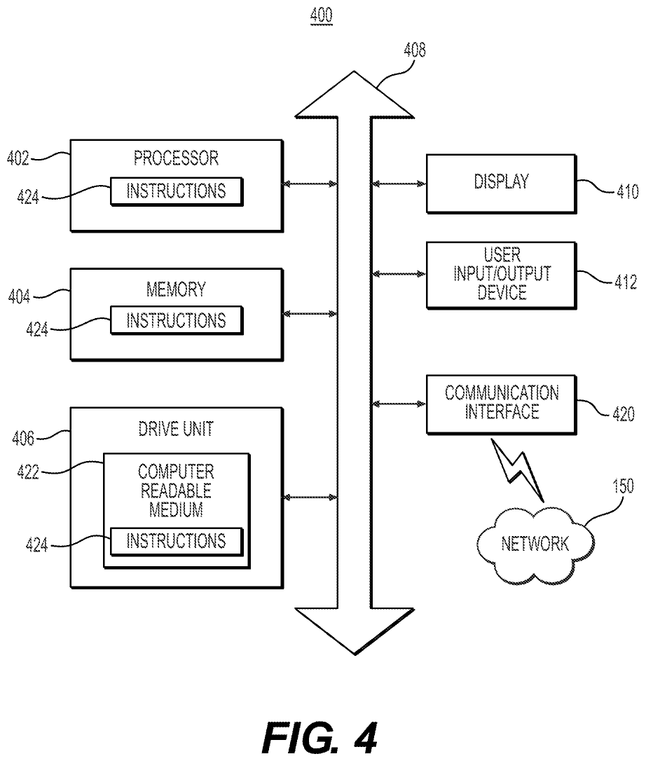

The first user device 110 and the second user device 120 may be configured to enable the user 105 to access and/or interact with other systems in the environment 100. For example, the first user device 110 and the second user device 120 may be computer systems (e.g., as shown in FIG. 4) such as, for example, desktop computers, mobile devices, tablets, smart devices, and the like. In some embodiments, the first user device 110 and the second user device 120 may include microphones 114 and 124, respectively, and storage 112 and 122, respectively. These components may be used to capture audio signals, store and process object protection information, and the like. In some embodiments, the user devices 110 and 120 may include one or more electronic application(s), e.g., a program, plugin, browser extension, etc., installed on the storage 112 and 122, respectively. In some embodiments, the electronic application(s) may be associated with one or more of the other components in the environment 100. For example, the electronic application(s) may include one or more of system control software, system monitoring software, software development tools, etc.

In various embodiments, the electronic network 150 may be a wide area network (“WAN”), a local area network (“LAN”), personal area network (“PAN”), or the like. In some embodiments, electronic network 150 includes the Internet, and information and data provided between various systems occur online. “Online” may mean connecting to or accessing source data or information from a location remote from other devices or networks coupled to the Internet. Alternatively, “online” may refer to connecting or accessing an electronic network (wired or wireless) via a mobile communications network or device. The Internet is a worldwide system of computer networks—a network of networks in which a party at one computer or other device connected to the network can obtain information from any other computer and communicate with parties of other computers or devices. The most widely used part of the Internet is the World Wide Web (often abbreviated “WWW” or called “the Web”). A “website page” generally encompasses a location, data store, or the like that is, for example, hosted and/or operated by a computer system so as to be accessible online, and that may include data configured to cause a program such as a web browser to perform operations such as send, receive, or process data, generate a visual display and/or an interactive interface, or the like.

The first user device 110 and the second user device 120 may include object protection information associated with the devices that are being monitored for potential damage. The first and second user devices 110, 120, having microphones 114, 124 and storages 112, 122, may communicate with the protection indication system 130 to provide or receive information related to object protection indicators, device warranty status, or analysis. The first and second user devices 110, 120, having microphones 114, 124 and storages 112, 122, respectively, may further communicate with the services system 140 and exchange information such as audio information, transaction information, object protection and/or warranty information, user profile information, or the like.

The first user device 110 and the second user device 120, as well as any additional user devices in the environment 100, may include microphones 114 and 124, respectively, which are configured to intake audio information. The audio information may comprise various sounds, words, or phrases that can indicate the status of an object, such as it being broken, failing, lost, or experiencing other operational issues. The microphones 114 and 124 may be integrated into the user devices or connected externally as peripheral devices.

In some embodiments, the user devices may be configured to actively monitor the audio environment surrounding the devices to detect and analyze audio signals that may be indicative of a damaged or malfunctioning object. The user devices may employ audio processing algorithms, machine-learning models, or pattern recognition techniques to identify and interpret the audio information, determining whether it is relevant to the object's status.

The user devices may interact with one another to ensure or verify the accuracy and reliability of the audio information. This interaction may involve sharing and comparing the audio signals, timestamps, or other relevant data between the user devices. The devices may use techniques such as triangulation, time difference of arrival (TDOA), or other localization methods to improve the spatial accuracy of the detected audio information. While two user devices are depicted, in some embodiments, environment 100 may include three or more user devices.

Additionally, the user devices may collaborate to enhance the audio signal quality by employing noise reduction techniques, signal filtering, or audio source separation algorithms. By combining the audio information from multiple user devices, the system may improve the accuracy and reliability of the object status determination.

The user devices may communicate with each other directly, using device-to-device communication protocols such as Bluetooth, Wi-Fi Direct, or near-field communication (NFC), or indirectly through the network 150. The devices may share the processed audio information, status determinations, or any other relevant data with the protection indication system 130, which may further analyze the information, determine the object's warranty status, and provide an object protection indicator to the user or other interested parties.

Object protection information may be associated with individual devices or users, depending on the context and requirements of a particular application. In some embodiments, object protection information may include data that characterizes devices based on various attributes, such as device type, brand, warranty status, materials, functionality, or other relevant features. This object protection information may be used to organize, filter, or search for devices within a database or online platform, and may be beneficial for users and service providers in facilitating device monitoring, damage assessment, and warranty claims.

Object protection information may come in various forms, such as audio signals captured by the microphones 114 and 124, device metadata, warranty records, and the like, to effectively monitor and characterize devices for potential damage. Audio signals provide real-time data about a device's operational status, serving as a rich source of object protection information. Device metadata, often stored within a device's internal memory or associated with a user account, can contain valuable information about the device's specifications, usage history, and warranty status, which can be utilized for protection indication purposes. Warranty records, on the other hand, represent a concise summary of the warranty terms, conditions, and coverage associated with a device, and can be instrumental in determining eligibility for repair or replacement services. It will be appreciated that object protection information may come from the object itself (e.g., a mobile phone in taking audio information about itself) or may come from a separate object (e.g., a smart home speaker in taking audio information about the mobile phone).

The services system 140, having storage 142, may include financial services data related to transactions, user accounts, object protection information (such as warranty information), or other financial activities. The services system 140 may interact with the protection indication system 130 to exchange data for the purpose of analyzing transaction patterns, generating insights, or providing customized recommendations and/or notifications based on the object protection information.

The services system 140 may include financial services data, which encompasses various types of information related to the financial activities, accounts, and profiles of users. This data may include user profiles, transaction details, account balances, credit scores, and other relevant financial information associated with a user. User profiles may consist of personal information, such as name, address, contact details, and financial account numbers, as well as preferences and settings related to the user's financial services.

Transaction data within the financial services data may comprise a comprehensive record of the user's financial activities, including purchase history, payments, deposits, withdrawals, transfers, and other transactions associated with their accounts. This transaction data can provide valuable insights into the user's spending habits, preferences, and financial behaviors, enabling the services system 140 to offer personalized services, targeted offers, and tailored recommendations to the user. This transaction data may also provide insights as to currently possessed objects of the user and warranty status of those objects.

In some embodiments, the environment 100 may include additional components or systems that interact with the protection indication system 130 or other components in the environment. These additional components may provide supplemental data, services, or functionality to support the object status determination process or to enhance the user experience. For example, a replacement server may be an additional component, which may include a replacement server database. The replacement server data may store object-related information, such as information related to object maintenance, repair services, replacement reduction, object disposal, or sale or contribution information, or other input replacement coverage information from one or more other user. The replacement server and/or the replacement server database may be associated with one or more other components within the environment 100, such as services system 140.

The service system 140, one or more user device 110, 120, the protection indication system 130, or one or more other system may include a user object list. In some embodiments, the user object list is a data structure or file format for organizing, storing, and managing information related to user-owned objects, such as electronics. The list includes various data fields, such as a unique identifier, object name, category, manufacturer, model number, date of acquisition, warranty information, purchase location, purchase price, and additional relevant data.

As discussed in further detail below, the protection indication system 130 may generate, store, train, or use a machine-learning model configured to find associations between audio signals, object status, and/or warranty information. The protection indication system 130 may include a machine-learning model and/or instructions associated with the machine-learning model, e.g., instructions for generating a machine-learning model, training the machine-learning model, using the machine-learning model, etc. The protection indication system 130 may include instructions for retrieving audio information, adjusting object status determinations, e.g., based on the output of the machine-learning model, and/or operating the first user device 110 and second user device 120 to output object protection indicators, e.g., as adjusted based on the machine-learning model. The protection indication system 130 may include training data, e.g., audio data, and may include ground truth, e.g., object status and warranty information.

In some embodiments, a system or device other than the protection indication system 130 may be used to generate and/or train the machine-learning model. For example, such a system may include instructions for generating the machine-learning model, the training data and ground truth, and/or instructions for training the machine-learning model. A resulting trained-machine-learning model may then be provided to the protection indication system 130.

Generally, a machine-learning model includes a set of variables, e.g., nodes, neurons, filters, etc., that are tuned, e.g., weighted or biased, to different values via the application of training data. In supervised learning, e.g., where a ground truth is known for the training data provided, training may proceed by feeding a sample of training data into a model with variables set at initialized values, e.g., at random, based on Gaussian noise, a pre-trained model, or the like. The output may be compared with the ground truth to determine an error, which may then be back-propagated through the model to adjust the values of the variables.

Training may be conducted in any suitable manner, e.g., in batches, and may include any suitable training methodology, e.g., stochastic or non-stochastic gradient descent, gradient boosting, random forest, etc. In some embodiments, a portion of the training data may be withheld during training and/or used to validate the trained machine-learning model, e.g., compare the output of the trained model with the ground truth for that portion of the training data to evaluate an accuracy of the trained model. The training of the machine-learning model may be configured to cause the machine-learning model to learn associations between audio signals, object status, and/or warranty information, such that the trained machine-learning model is configured to determine an output object status or warranty coverage in response to the input audio signals based on the learned associations.

In various embodiments, the variables of a machine-learning model may be interrelated in any suitable arrangement in order to generate the output. For example, in some embodiments, the machine-learning model may include audio-processing architecture that is configured to identify, isolate, and/or extract features, patterns, or structure in one or more of the audio signals. In some instances, different samples of audio data and/or input data may not be independent. Thus, in some embodiments, the machine-learning model may be configured to account for and/or determine relationships between multiple samples. For example, in some embodiments, the machine-learning model of the protection indication system 130 may include a Recurrent Neural Network (“RNN”). Generally, RNNs are a class of feed-forward neural networks that may be well adapted to processing a sequence of inputs. In some embodiments, the machine-learning model may include a Long Short Term Memory (“LSTM”) model and/or Sequence to Sequence (“Seq2Seq”) model. An LSTM model may be configured to generate an output from a sample that takes at least some previous samples and/or outputs into account.

Although depicted as separate components in FIG. 1A, it should be understood that a component or portion of a component in the environment 100 may, in some embodiments, be integrated with or incorporated into one or more other components. For example, a portion of the first user device 110 may be integrated into the second user device 120, or the like. In another example, the protection indication system 130 may be integrated into the services system 140, or the like. In some embodiments, operations or aspects of one or more of the components discussed above may be distributed amongst one or more other components. Any suitable arrangement and/or integration of the integration of the various systems and devices of the environment 100 may be used.

Further aspects of the machine-learning model and/or how it may be utilized for determining object status or warranty coverage are discussed in further detail in the methods below. In the following methods, various acts may be described as performed or executed by a component from FIG. 1A such as the first user device 110, second user device 120, the protection indication system 130, or components thereof. However, it should be understood that in various embodiments, various components of the environment 100 discussed above may execute instructions or perform acts including the acts discussed below. An act performed by a device may be considered to be performed by a processor, actuator, or the like associated with that device. Further, it should be understood that in various embodiments, various steps may be added, omitted, and/or rearranged in any suitable manner.

FIG. 1B illustrates an exemplary protection indication system 130, which may be associated with or integrated into the environment 100, and utilized for processing and determining object status or warranty coverage based on audio data related to one or more user devices. The protection indication system 130 includes various components that work together to intake, process, and analyze audio data obtained from user devices, such as first user device 110 and second user device 120. These components include the collection module 132, processing module 134, machine-learning module 136, and the user interface module 138.

The collection module 132 is responsible for gathering the audio data during a user session. This may involve receiving audio data from the microphones (e.g., microphone 114 and microphone 124) of the respective user devices. The collected data may include audio signals, timestamps, and other relevant information associated with the user devices or their environment.

Once the collection module 132 has gathered the necessary audio data, the processing module 134 processes and prepares the data for analysis by the machine-learning module 136. The processing module 134 may involve cleaning the data, removing irrelevant or redundant information, and converting the data into a suitable format for further processing by the machine-learning module 136.

The machine-learning module 136 receives the prepared data from the processing module 134 and applies machine-learning algorithms and models to determine object status or warranty coverage based on the input data. The machine-learning module 136 may use various algorithms such as supervised learning, unsupervised learning, or reinforcement learning, and may utilize a variety of models, including neural networks, decision trees, or support vector machines, to accomplish its task.

After the machine-learning module 136 has determined the object status or warranty coverage based on the input data, the user interface module 138 presents the results to the user (user 105), who may be a customer, a merchant, or a financial services provider. The user interface module 138 can provide an interactive and intuitive interface, enabling the user to view, modify, or confirm the determination results. The user interface module 138 may also allow the user to provide feedback or additional information to improve the determination process or adjust the machine-learning model accordingly.

FIG. 1C presents a more detailed view of the machine-learning module 136 and its relationship with a protection indication model 137 within the protection indication system 130. As previously mentioned, the machine-learning module 136 applies machine-learning algorithms and models to determine object status or warranty coverage based on the prepared input data provided by the processing module 134.

The machine-learning module 136 may encompass various subcomponents and processes to ensure accurate and efficient protection indication. One element of the machine-learning module 136 is the protection indication model 137, which serves as the computational model responsible for making predictions and classifications based on the input data. The protection indication model 137 may be a pre-trained model or a model specifically designed and trained for the task of determining object status or warranty coverage within the given context.

The development of the protection indication model 137 may involve multiple steps, including feature extraction, model selection, training, validation, and evaluation. Feature extraction is the process of identifying and extracting relevant features from the prepared data, which will be used as input for the protection indication model 137. These features may include textual information, audio information, or any other relevant data points that can aid in the determination process.

Model selection is the process of choosing the most suitable machine-learning algorithm or model for the protection indication task. This may involve comparing various algorithms such as decision trees, support vector machines, neural networks, or ensemble methods, and selecting the one that provides the best performance based on predefined criteria, such as accuracy or computational efficiency.

Once the appropriate model has been selected, the protection indication model 137 is trained using a dataset that includes both input features and corresponding ground truth labels. The training process involves adjusting the model's parameters to minimize the error between the model's predictions and the ground truth labels. This process may include using techniques such as gradient descent, backpropagation, or other optimization algorithms.

After the training process, the protection indication model 137 may be validated and evaluated using a separate dataset not used during training. This allows for an assessment of the model's performance on unseen data, providing insights into its generalization capabilities and ensuring that it can accurately determine object status or warranty coverage in real-world scenarios.

Once the protection indication model 137 has been trained, validated, and evaluated, it is integrated into (or otherwise made available to) the machine-learning module 136, which then utilizes the model to make predictions and classifications based on the prepared input data. The results generated by the protection indication model 137 are then passed on to the user interface module 138 for presentation to the user, as previously discussed.

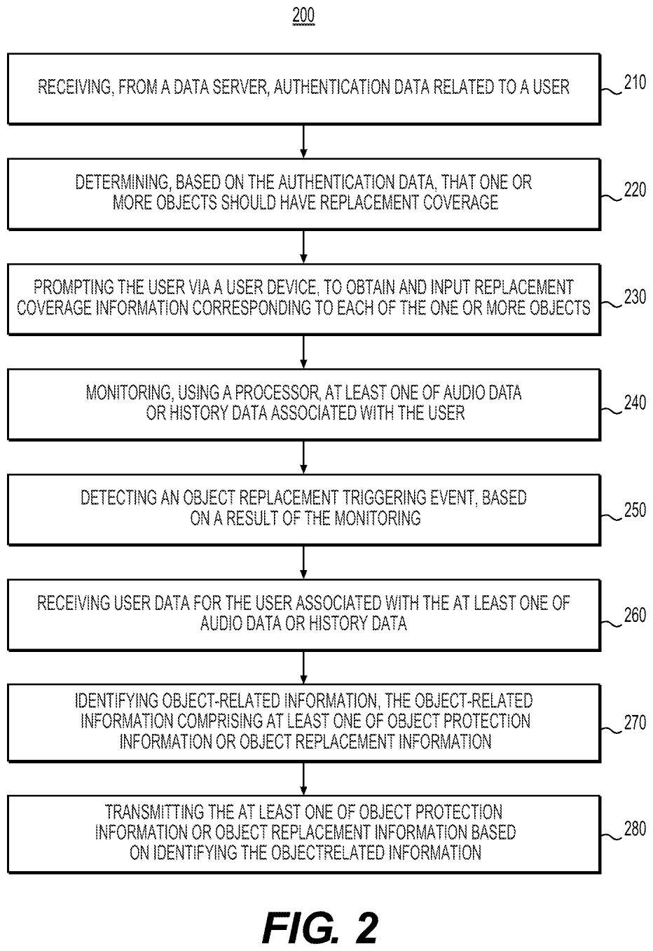

FIG. 2 illustrates an exemplary process 200 for providing an object protection indicator, e.g., by utilizing a trained machine-learning model such as a machine-learning model trained according to one or more embodiments discussed above. The exemplary process 200 may be a computer-implemented method, and may be considered a method for offering a safeguarding indicator for an item.

At step 210, the protection indication system 130 receives authentication data related to a user from a data server. The authentication data may include a variety of information such as the user's unique identification (ID), username, password, biometric data, or any other suitable data that verifies the user's identity.

The data server, which may be part of the services system 140 or another server in the environment 100, is responsible for securely storing and managing user data, including authentication data. In some embodiments, the data server may be a cloud-based server or a remote server, allowing access to the authentication data from multiple devices or locations.

Receiving the authentication data ensures that only authorized users can access the protection indication system 130 and its features. This process may involve establishing a secure connection between the user's device (e.g., first user device 110 or second user device 120) and the data server through the network 150. The secure connection may use encryption or other security measures to protect the transmission of sensitive information, such as authentication data, from unauthorized access or tampering.

Upon receiving the authentication data, the protection indication system 130 may verify the user's identity by comparing the received data with the stored data in the data server or the storage 142 of the services system 140. If the user's identity is successfully authenticated, the system proceeds to the next step (step 220) of determining whether one or more objects should have replacement coverage. In some embodiments, the authentication may be performed by the services system 140, such that the services system conducts actions related to prompting for the authentication, receiving the authentication data, and verifying authentication of the user. In such embodiments, upon a determination that authentication is approved, the services system 140 then provides an indication to the protection indication system 130 that the user is authenticated.

In some embodiments, additional security measures such as two-factor authentication (2FA) or multi-factor authentication (MFA) may be employed to enhance the security of the user's account and the protection indication process.

At step 220, the method includes determining, based on the authentication data received in step 210, whether one or more objects should have replacement coverage. Replacement coverage refers to the coverage provided by an insurance or warranty policy that covers the cost of replacing an object in case of loss, theft, or damage.

To perform this determination, the protection indication system 130 may access user-associated data stored in the services system 140 or other data servers in the environment 100. This data can include information about the user's existing insurance policies, warranty agreements, and object ownership or usage details. The storage 142 in the services system 140 may contain records of the user's warranty policies, object-related information, or the like.

The processing module 134 within the protection indication system 130 processes the user-associated data to identify objects that may require replacement coverage. This analysis may involve applying predefined rules, algorithms, or machine-learning models, such as the protection indication model 137, to assess the risk factors associated with each object. Risk factors can include the object's age, condition, value, usage frequency, and any other relevant factors that may impact the likelihood of requiring replacement.

The processing module 134 may also, or alternatively, operate to modify one or more pieces of data to prepare the data to a form suitable for applying to one or more other elements within the environment 100, such as passing the data to machine-learning module 136 for application to one or more machine-learning model.

In some embodiments, the processing module 134 may also consider external factors such as regional or global trends, statistical data, or expert opinions to enhance the accuracy and relevance of the determination. For example, the system may take into account the prevalence of theft or damage incidents for a particular object type within a geographic area. By way of another example, the system may take into account information related to government-mandated protection grants or regulatory protection grants, such as settlements, disaster relief plans, or the like.

The determination of whether the object(s) have replacement coverage may be performed by a simple lookup and/or comparison against warranty data within the services system 140. In this approach, the processing module 134 within the protection indication system 130 may access the warranty data stored in the storage 142 of the services system 140.

The warranty data may include records of active warranties associated with the user's owned or used objects. These records may contain information such as the object's identifier, warranty start and end dates, coverage details, and any special terms or conditions. To perform the lookup and comparison, the processing module 134 may retrieve a user's object list, which can be obtained from the authentication data received in step 210, from the user's devices (e.g., first user device 110 or second user device 120), or as a separate data entry in a system, such as services system 140.

Once the user's object list is obtained, the processing module 134 may iterate through the list, comparing each object's identifier with the identifiers in the warranty data records. If a match is found, the system can determine whether the warranty coverage is still active by comparing the current date with the warranty start and end dates. If the warranty is active, it can be concluded that the object has replacement coverage.

In cases where an object identifier is not found in the warranty data records or the warranty has expired, the processing module 134 may access the user's insurance policies stored in the storage 142 of the services system 140. The system can then determine if any of the insurance policies provide replacement coverage for the object in question. If neither warranty nor insurance coverage is found for an object, the protection indication system 130 may determine that the object should have replacement coverage, prompting the user to obtain and input the necessary information as described in step 230.

At step 230, the method includes prompting a user via a user device, such as the first user device 110 or second user device 120, to obtain and input replacement coverage information corresponding to each of the one or more objects that may have been determined in step 220 that should have replacement coverage. The replacement coverage information may include images or text related to replacement coverage. The replacement coverage information may be stored in a replacement server database as described herein. This step ensures that the user is made aware of the need or preference for replacement coverage for the identified object(s) and can take the necessary actions to acquire such coverage.

To facilitate this process, the user interface module 138 within the protection indication system 130 generates a user-friendly interface that is caused to be displayed on the user device. This interface may provide a clear and concise summary of the object(s) requiring replacement coverage and may include relevant details such as the object's identifier, description, and the reason for the need for replacement coverage (e.g., expired warranty or lack of insurance coverage).

The user interface may also provide guidance on how to obtain replacement coverage information for the identified object(s). This guidance may include instructions on contacting insurance providers, warranty providers, or other relevant entities that can offer replacement coverage for the object(s). Additionally, the user interface may provide links to online resources or tools that can assist the user in obtaining quotes or purchasing replacement coverage.

In some embodiments, an interactive agent within the protection indication system can enhance the user experience by providing responsive coverage information for the identified objects requiring replacement coverage. This agent, which can be an AI-powered chatbot or a virtual assistant, can interact with the user through a conversational interface that is integrated with the user-friendly interface displayed on the user device.

The interactive agent is designed to understand user queries and provide relevant responses in real-time. It can access the one or more database of the system, such as a protection indication system database, coverage information from insurance and warranty providers, and other sources of information to provide the most accurate and up-to-date coverage details to the user.

Once the user has obtained the necessary replacement coverage information, they can input this information into the user interface. The input may include coverage details such as the coverage provider's name, policy number, coverage start and end dates, coverage limits, and any special terms or conditions. To facilitate the input process, the user interface may provide text fields, dropdown menus, checkboxes, or other input elements that allow the user to easily input the required information. In some embodiments, the user is provided with the ability to upload one or more documents which contain information regarding the replacement coverage information. In such embodiments, the document is processed to recognize text and other information in the document in order to intake the replacement coverage information.

In some embodiments, the user may have already or previously input replacement coverage information. In such embodiments, the user may be presented with the previously entered information and requested to verify such information.

Upon receiving (or, in some embodiments, verifying) the user's input of the replacement coverage information, the protection indication system 130 stores this information in the storage 112 or 122 of the user's device or within the storage 142 of the services system 140, or within a storage associated with the protection indication system 130, for future reference and use in the subsequent steps of the process 200.

At step 240 the method includes monitoring at least one of audio data or history data associated with the user. The monitoring process may be initiated based on receiving an opt-in indication from the user, ensuring that the user has consented to the monitoring and usage of their data for the purpose of providing object protection indicators.

The collection module 132 within the protection indication system 130 is responsible for gathering the required data for monitoring. The audio data may be collected through the microphone 114 or 124 of the first user device 110 or second user device 120, respectively. The audio data may include conversations or sounds related to the user's interaction with the objects, indicating events such as usage, maintenance, or damage to the objects.

The history data may be gathered from various sources, such as the storage 112 or 122 of the user devices, the storage 142 of the services system 140, or other data sources accessible through the network 150. The history data may comprise records of the user's transactions, warranty claims, insurance claims, maintenance records, browser history data, or other events relevant to the objects in question.

Upon collection, the processing module 134 within the protection indication system 130 preprocesses the audio and history data, preparing it for further analysis. This may include noise reduction, normalization, feature extraction, or other data processing techniques to ensure that the data is in a suitable format for analysis by the machine-learning module 136.

The machine-learning module 136, in conjunction with the protection indication model 137, then analyzes the preprocessed data to identify patterns, trends, or anomalies that may indicate a potential object replacement triggering event. For example, the machine-learning module 136 may detect an increase in audio levels or specific audio patterns that suggest an object has been damaged or is in need of repair or replacement.

It is important to note that the monitoring process in step 240 respects the user's privacy by initiating the process only after receiving the user's opt-in indication. Additionally, the data collected and used for monitoring purposes may be anonymized, encrypted, or otherwise secured to ensure the user's privacy is maintained throughout the process.

In step 250, the method includes detecting an object replacement triggering event based on the results of the monitoring performed in step 240. The object replacement triggering event may be an occurrence or a set of conditions that indicate a need for object replacement or additional protection coverage.

The machine-learning module 136, utilizing the protection indication model 137, analyzes the preprocessed audio data and history data obtained from the monitoring to identify potential object replacement triggering events. This analysis may involve the application of various machine-learning algorithms, such as supervised learning, unsupervised learning, reinforcement learning, or deep learning, or the like, to discern patterns or anomalies that signify an object replacement triggering event.

Some possible object replacement triggering events may include, but are not limited to, detection of sounds indicative of object damage or malfunction (such as sounds made by the device itself or audio indications from a user, such as words or phrases said which indicate object damage or intent to replace), identification of recurring maintenance issues, detection of usage patterns that exceed the object's normal operating range, or a combination thereof. Additionally, the triggering event may be based on historical data, such as warranty expiration, an increase in insurance claims, a pattern of user transactions suggesting repeated issues, or other relevant factors.

The audio data and historical data may be used together in the protection indication system 130 to provide a more comprehensive and accurate assessment of the object replacement triggering events. Combining these two types of data allows the system to consider both real-time information and past patterns or trends to make informed decisions.

When used together, the audio and historical data can complement and reinforce each other, enabling the machine-learning module 136 and the protection indication model 137 to make more accurate predictions and detections. For instance, the system may detect an unusual sound from the audio data or a verbal indication from a user, which by itself may not be enough to trigger an object replacement event. However, when combined with historical data showing recurring maintenance issues (either for the specific device or devices which are similar to the specific device) or previous claims, the system may determine that the combination of the audio event and the historical pattern indeed warrants an object replacement triggering event.

The integration of audio data and historical data may also enable the system to identify and learn from patterns that may not be evident when analyzing each type of data in isolation. By training the protection indication model 137 on a dataset that includes both audio and historical data, the model can learn to extract and recognize features from both data types and identify relationships between them.

Upon detecting an object replacement triggering event, the protection indication system 130 may proceed to step 260, where it receives user data associated with the monitored audio data or history data. This user data may include user preferences, user feedback, or additional contextual information related to the objects or the user's interactions with them.

The detection of an object replacement triggering event may be customizable and adaptable based on user input or changing conditions. The protection indication model 137 may be updated or retrained periodically to improve its accuracy and effectiveness in detecting object replacement triggering events. Moreover, the system may provide an option for users to adjust the sensitivity or parameters of the triggering events, allowing for greater personalization and relevance to the user's specific needs and preferences.

In step 260 of process 200, the protection indication system 130 receives user data for a user associated with at least one of audio data or history data. The user data may include various types of information, such as registered protection information input by the user or operation data retrieved from an operation database.

Registered protection information input by the user may encompass details related to the objects, such as object type, brand, model, age, condition, serial number, or any other relevant attributes. This information may be input by the user through a user interface provided by the user interface module 138 on the user devices 110 or 120. The user may input this data in response to the prompt in step 230, where they are asked to obtain and input replacement coverage information corresponding to each of the one or more objects. The registered protection information may be used to facilitate the identification of objects and their associated protection or replacement coverage.

Operation data, on the other hand, may be obtained from an operation database, which could be part of the services system 140, the storage 112 or 122 of the user devices, or an external data server. This operation data may include information about user interactions with the objects, past transactions, maintenance records, or other relevant events. Such data can help provide context and improve the accuracy of detecting object replacement triggering events.

When the protection indication system 130 receives the user data, the collection module 132 may store the data in the storage components of the system, such as the storage 112, 122, or 142. The processing module 134, in conjunction with the machine-learning module 136, can then process and analyze the user data in combination with the audio data and history data monitored in step 240. The integration of these data sources allows the system to better identify object replacement triggering events in step 250 and to derive more accurate and personalized object protection and replacement information for the user.

The machine-learning module 136, utilizing the protection indication model 137, may employ various machine-learning algorithms, statistical models, or pattern recognition techniques to correlate and analyze the user data in conjunction with the audio and history data. This analysis may reveal patterns, trends, or anomalies that could indicate potential object replacement triggering events, such as frequent malfunctioning, significant wear and tear, or user dissatisfaction with the object.

Once the user data has been received, processed, and analyzed, the system may proceed to step 270, where it identifies object-related information. This object-related information may comprise object protection information or object replacement information, which can be based on the user data, audio data, and history data.

The process 200 may further include identifying an object corresponding to the object replacement triggering event based on the user data. This step may involve the use of the machine-learning module 136 and the protection indication model 137, which have been trained to correlate other audio data or other history data associated with other object protection data to determine trends for identifying an object in need of replacement.

To perform this identification, the machine-learning module 136 may receive input data comprising the user data, audio data, and history data associated with the user. This data may include, but is not limited to, object usage patterns, user feedback, object condition, object age, or the like. Using the protection indication model 137, the machine-learning module 136 may analyze the input data and identify the object that corresponds to the detected object replacement triggering event.

The protection indication model 137 may be trained using a variety of machine-learning algorithms, such as supervised learning, unsupervised learning, reinforcement learning, or the like. The model may be based on a dataset of other audio data, other history data, and other object protection data, which may include information related to object replacement events, object conditions, user feedback, and other relevant factors. By learning from this dataset, the model can recognize patterns and trends that may indicate an object in need of replacement.

Once the object corresponding to the object replacement triggering event has been identified, the system may proceed to step 270, where it identifies object-related information. This object-related information may comprise at least one of object protection information or object replacement information, which can be based on the user data, audio data, and history data, as well as the identified object.

At step 270, the process may include identifying object-related information, which may comprise at least one of object protection information or object replacement information. This step may involve the processing module 134 and the machine-learning module 136 working together to analyze the user data, audio data, history data, and the identified object corresponding to the object replacement triggering event.

The object protection information may include guarantee information for the object, which may encompass various types of guarantees or warranties provided by manufacturers, retailers, or third-party insurance providers. Guarantee information may cover aspects such as repair services, replacement parts, or full replacement of the object, and may vary in duration, conditions, and coverage limitations.

To identify the guarantee information, the processing module 134 may access the services system 140 via the network 150. The services system 140 may store guarantee information in the storage 142, which could include details on the types of guarantees associated with the object, the terms and conditions of the guarantees, and other relevant data. The processing module 134 may retrieve the guarantee information from the storage 142 by matching the identified object with the corresponding guarantee information using, for example, unique identifiers such as product serial numbers or purchase transaction identifiers.

In some embodiments, the machine-learning module 136 may also play a role in identifying guarantee information. For instance, the machine-learning module 136, utilizing the protection indication model 137, may be trained to predict or estimate guarantee information based on patterns and trends observed in the dataset of other audio data, other history data, and other object protection data. This approach may be useful in cases where the guarantee information is not readily available or cannot be directly accessed from the services system 140. In such cases, the machine-learning module 136 may analyze the user data, audio data, and history data, along with other relevant factors, to estimate the guarantee information for the identified object.

Once the guarantee information is identified, the system may proceed to determine if the object replacement information is also needed. Object replacement information may include details regarding the replacement process, such as eligibility for replacement, associated costs, or required documentation. The processing module 134, in conjunction with the machine-learning module 136 and the protection indication model 137, may assess whether the identified object is eligible for replacement based on the guarantee information and other relevant factors, such as object condition, user feedback, or object age.

In some cases, the object replacement information may be derived from the guarantee information itself or other sources, such as the user's insurance policy or terms and conditions set forth by the manufacturer or retailer. The processing module 134 may access and retrieve such information from the services system 140 or other relevant databases via the network 150.

A GUI (graphical user interface) display presents the object protection information to the user 105 in an intuitive and easy-to-understand format. The method may include providing, to a GUI display of a user device, icon information comprising contact information related to the object protection information. In some embodiments, the user interface module 138 generates and sends icon information to be displayed on the GUI of a user device, such as the first user device 110 or the second user device 120.

The icon information may include graphical representations or symbols that convey the object protection information in a visually appealing manner. These icons may be designed to represent different aspects of the object protection information, such as coverage status, object type, guarantee period, or replacement conditions. For example, an icon with a green checkmark may indicate that the object is fully covered, while a red exclamation mark may signify that the coverage has expired or is inadequate.

The contact information related to the object protection information may also be displayed within the GUI, either as part of the icon information or separately. This contact information may include phone numbers, email addresses, or website links to the relevant services system 140, insurance providers, or other entities responsible for providing replacement coverage or assistance. The user 105 can access this contact information directly from the GUI to initiate communication with these entities, streamlining the process of obtaining necessary protection or replacement services.

The GUI display may also incorporate interactive elements that facilitate user engagement and navigation. For instance, the user 105 can click or tap on the icons or contact information to access additional details or initiate specific actions, such as updating coverage, submitting a replacement request, or contacting customer support. The interactive elements may be responsive to various user inputs, such as mouse clicks, touchscreen gestures, or keyboard commands.

Moreover, the GUI display may be customizable to accommodate individual user preferences or needs. The user 105 can adjust the layout, color scheme, font size, or other visual elements to enhance the readability and accessibility of the object protection information. In some embodiments, the GUI display may also support multiple languages, enabling users from diverse linguistic backgrounds to understand and interact with the object protection information effectively.

In the process 200 for providing an object protection indicator, the protection indication system 130 may receive updated object protection data and provide a real-time notification to the user 105 related to the updated object protection data. This updated information can help the user 105 make informed decisions regarding their objects and their replacement coverage.

The protection indication system 130 may periodically or dynamically receive updated object protection data from various sources, including the services system 140, external data servers, user devices 110 and 120, or other relevant entities, such as the microphones associated with the first and second user devices 110, 120. This data may encompass changes in the object's coverage, guarantee information, replacement conditions, or other pertinent aspects that can impact the object's protection status.

The collection module 132 can be configured to gather this updated information from the various sources and store it in the storage 112 or 122, as appropriate. The processing module 134 can then analyze the received data to determine whether any changes have occurred in the object protection information since the last update. The machine-learning module 136 may also be involved in identifying trends, patterns, or correlations within the updated data to further enhance the accuracy and relevance of the object protection information.

Upon detecting any changes in the object protection information, the user interface module 138 may generate a real-time notification to alert the user 105 of the updates. This notification can be sent to the user's device, such as the first user device 110 or the second user device 120, via the network 150. The notification may be presented in various formats, including pop-up messages, banners, push notifications, or other suitable means that ensure the user 105 is promptly informed of the changes.

The real-time notification may include a summary of the updated object protection data, highlighting aspects or changes that the user 105 should be aware of. For instance, the notification may inform the user 105 of a change in coverage status, an approaching expiration date for a guarantee, or new replacement conditions that have been introduced. In some embodiments, the notification may also include action items or recommendations for the user 105 to consider in response to the updated information.

In the process 200 for providing an object protection indicator, the protection indication system 130 may be configured to determine one or more available object protection options for the object-related information, and transmit the one or more available object protection options along with the object protection information or the object replacement information. This can assist the user 105 in making informed decisions regarding the protection and replacement coverage for their objects.

The processing module 134, in conjunction with the machine-learning module 136, may analyze the object-related information to determine suitable object protection options for the user 105. These options may include different coverage plans, guarantees, warranties, insurance policies, or the like, that are available for the specific object, considering factors such as the object's value, age, usage history, and other relevant parameters.

The machine-learning module 136, using the protection indication model 137, may process historical data, trends, and correlations associated with other objects and their protection plans to identify optimal protection options for the given object-related information. The machine-learning module 136 can continuously learn and adapt its recommendations based on new data, ensuring that the protection options offered to the user 105 are relevant and up-to-date.

At step 280, once the one or more available object protection options have been determined, the user interface module 138 may be responsible for transmitting this information to the user 105. This transmission may occur via the network 150 and may be directed to the user's device, such as the first user device 110 or the second user device 120.

The transmitted data may include the object protection information or the object replacement information, as well as the available object protection options. This comprehensive data presentation allows the user 105 to compare the various protection options, assess their object's current protection status, and make informed decisions on which option(s) to select.

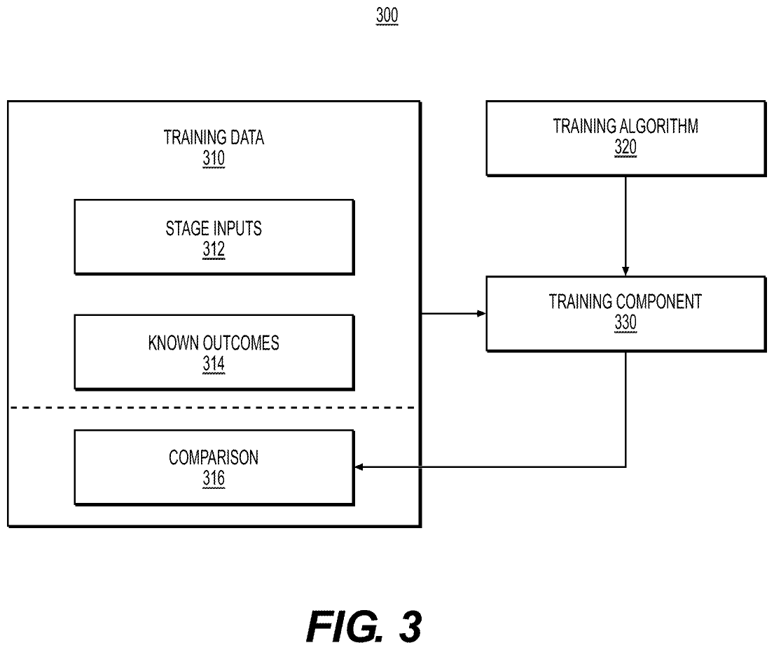

One or more implementations disclosed herein include and/or are implemented using a machine-learning model, such as the protection indication model described in the context of the present discussion. For example, one or more of the modules of the protection indication system 130 are implemented using a machine-learning model and/or are used to train the machine-learning model. FIG. 3 shows an example machine-learning training flow chart 300, according to some embodiments of the disclosure. Referring to FIG. 3, a given machine-learning model is trained using the training flow chart 300. The training data 310 includes one or more of stage inputs 312 and the known outcomes 314 related to the machine-learning model to be trained. The stage inputs 312 are from any applicable source, including object data, warranty data, audio data, values, comparisons, and stage outputs, e.g., one or more outputs from one or more steps from FIG. 3. The known outcomes 314 are included for the machine-learning models generated based on supervised or semi-supervised training or can be based on known labels. An unsupervised machine-learning model is not trained using the known outcomes 314.

The training data 310 and a training algorithm 320, e.g., one or more of the modules implemented using the machine-learning model and/or used to train the machine-learning model, are provided to a training component 330 that applies the training data 310 to the training algorithm 320 to generate the machine-learning model. According to an implementation, the training component 330 is provided with comparison results 316 that compare a previous output of the corresponding machine-learning model to apply the previous result to re-train the machine-learning model. The comparison results 316 are used by the training component 330 to update the corresponding machine-learning model. The training algorithm 320 utilizes machine-learning networks and/or models including, but not limited to, deep learning networks such as Deep Neural Networks (DNN), Convolutional Neural Networks (CNN), Fully Convolutional Networks (FCN), and Recurrent Neural Networks (RCN), probabilistic models such as Bayesian Networks and Graphical Models, classifiers such as K-Nearest Neighbors, and/or discriminative models such as Decision Forests and maximum margin methods, the model specifically discussed herein, or the like.

The machine-learning model used herein is trained and/or used by adjusting one or more weights and/or one or more layers of the machine-learning model. For example, during training, a given weight is adjusted (e.g., increased, decreased, removed) based on training data or input data. Similarly, a layer is updated, added, or removed based on training data and/or input data. The resulting outputs are adjusted based on the adjusted weights and/or layers.

The initial training of the machine-learning model for object protection indication can be completed by utilizing data that has been tagged for certain object protection indicators. This tagged data serves as a valuable input for supervised or semi-supervised learning approaches. The tagging process can be done manually or automatically, depending on the desired level of accuracy and available resources.

Manual tagging involves human annotators who examine data and assign appropriate object protection indication labels based on the content and context of the object. This method can yield high-quality labeled data, as humans can understand nuances and contextual information better than automated algorithms. However, manual tagging can be time-consuming and labor-intensive, especially when dealing with large datasets.

Automatic tagging, on the other hand, involves using algorithms, such as natural language processing techniques or pre-trained machine-learning models, to assign object protection labels to the data. This approach is faster and more scalable than manual tagging but may not be as accurate, particularly when dealing with complex or ambiguous objects. To improve the accuracy of automatic tagging, it can be combined with manual tagging in a semi-supervised learning approach, where a smaller set of manually tagged data is used to guide the automatic tagging process.

The data collection process can be done manually or using web-scraping techniques. Manual data collection involves browsing sources and gathering information, which can be time-consuming and may not cover all the available data on the internet. Web-scraping techniques, on the other hand, use automated tools and scripts to extract data from various sources, making the process faster and more comprehensive.

Once the data has been collected and tagged with appropriate object protection labels, it can be used as input for the machine-learning model's training process. The model will learn to recognize patterns and features in the data that correspond audio and/or object data with object protections. With sufficient training and accurate labeled data, the machine-learning model can become adept at identifying object protections when presented with new, unseen data, enabling an efficient and effective protection indication system.

It should be understood that embodiments in this disclosure are exemplary only, and that other embodiments may include various combinations of features from other embodiments, as well as additional or fewer features.

In general, any process or operation discussed in this disclosure that is understood to be computer-implementable, such as the processes illustrated in FIGS. 2-3, may be performed by one or more processors of a computer system, such any of the systems or devices in the environment 100 of FIG. 1A, as described above. A process or process step performed by one or more processors may also be referred to as an operation. The one or more processors may be configured to perform such processes by having access to instructions (e.g., software or computer-readable code) that, when executed by the one or more processors, cause the one or more processors to perform the processes. The instructions may be stored in a memory of the computer system. A processor may be a central processing unit (CPU), a graphics processing unit (GPU), or any suitable types of processing unit.

A computer system, such as a system or device implementing a process or operation in the examples above, may include one or more computing devices, such as one or more of the systems or devices in FIG. 1A. One or more processors of a computer system may be included in a single computing device or distributed among a plurality of computing devices. A memory of the computer system may include the respective memory of each computing device of the plurality of computing devices.

FIG. 4 is a simplified functional block diagram of a computer 400 that may be configured as a device for executing the methods of FIGS. 2-3, according to exemplary embodiments of the present disclosure. In various embodiments, any of the systems herein may be a computer 400 including, for example, a data communication interface 420 for packet data communication. The computer 400 also may include a central processing unit (“CPU”) 402, in the form of one or more processors, for executing program instructions. The computer 400 may include an internal communication bus 408, and a drive unit 406 (such as ROM, HDD, SDD, etc.) that may store data on a computer readable medium 422, although the computer 400 may receive programming and data via network communications. The computer 400 may also have a memory 404 (such as RAM) storing instructions 424 for executing techniques presented herein, although the instructions 424 may be stored temporarily or permanently within other modules of computer 400 (e.g., processor 402 and/or computer readable medium 422). The computer 400 also may include input and output ports 412 and/or a display 410 to connect with input and output devices such as keyboards, mice, touchscreens, monitors, displays, etc. The various system functions may be implemented in a distributed fashion on a number of similar platforms, to distribute the processing load. Alternatively, the systems may be implemented by appropriate programming of one computer hardware platform.

Program aspects of the technology may be thought of as “products” or “articles of manufacture” typically in the form of executable code and/or associated data that is carried on or embodied in a type of machine-readable medium. “Storage” type media include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer of the mobile communication network into the computer platform of a server and/or from a server to the mobile device. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to non-transitory, tangible “storage” media, terms such as computer or machine “readable medium” refer to any medium that participates in providing instructions to a processor for execution.

While the disclosed methods, devices, and systems are described with exemplary reference to transmitting data, it should be appreciated that the disclosed embodiments may be applicable to any environment, such as a desktop or laptop computer, an automobile entertainment system, a home entertainment system, etc. Also, the disclosed embodiments may be applicable to any type of Internet protocol.

It should be appreciated that in the above description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those skilled in the art. For example, in the following claims, any of the claimed embodiments can be used in any combination.

Thus, while certain embodiments have been described, those skilled in the art will recognize that other and further modifications may be made thereto without departing from the spirit of the invention, and it is intended to claim all such changes and modifications as falling within the scope of the invention. For example, functionality may be added or deleted from the block diagrams and operations may be interchanged among functional blocks. Steps may be added or deleted to methods described within the scope of the present invention.

The above disclosed subject matter is to be considered illustrative, and not restrictive, and the appended claims are intended to cover all such modifications, enhancements, and other implementations, which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description. While various implementations of the disclosure have been described, it will be apparent to those of ordinary skill in the art that many more implementations are possible within the scope of the disclosure. Accordingly, the disclosure is not to be restricted except in light of the attached claims and their equivalents.

What is claimed is:

1. A computer-implemented method for providing an object protection indicator, the method comprising:
monitoring, using a processor, at least one of audio data or history data associated with a user;
detecting an object replacement triggering event, based on a result of the monitoring;
receiving user data for a user associated with the at least one of audio data or history data;
identifying an object corresponding to the object replacement triggering event based on the user data;
identifying object-related information, the object-related information comprising at least one of an object protection information or an object replacement information; and
transmitting the at least one of the object protection information or the object replacement information based on identifying the object-related information.

2. The computer-implemented method of claim 1, wherein the monitoring is performed based on receiving an opt-in indication from the user.

3. The computer-implemented method of claim 1, wherein the user data includes registered protection information input by the user, or operation data from an operation database.

4. The computer-implemented method of claim 1, further comprising:
providing, to a GUI display of a user device, icon information comprising contact information related to the object protection information.

5. The computer-implemented method of claim 1, further comprising:
receiving updated object protection data; and
providing a real-time notification to the user related to the updated object protection data.

6. The computer-implemented method of claim 1, wherein identifying the object corresponding to the object replacement triggering event is performed using a machine-learning model, the machine-learning model trained by correlating other audio data or other history data associated with other object protection data to determine trends for identifying an object in need of replacement.

7. The computer-implemented method of claim 1, further comprising:
receiving other user data from one or more other users, and
identifying the object replacement information based on the other user data from the one or more other users.

8. The computer-implemented method of claim 7, further comprising:
determining one or more available object protection options for the object-related information; and
transmitting the one or more available object protection options along with the object protection information or the object replacement information.

9. The computer-implemented method of claim 1, wherein the object protection information includes guarantee information for the object.

10. The computer-implemented method of claim 1, further comprising:
transmitting an indication to the user to provide the object protection information.

11. A computer-implemented method for offering a safeguarding indicator for an item, the method comprising:
receiving, from a data server, authentication data related to a user;
determining, based on the authentication data, that one or more objects should have replacement coverage;
prompting the user via a user device, to obtain and input replacement coverage information corresponding to each of the one or more objects;
monitoring, using a processor, at least one of audio data or history data associated with the user;
detecting an object replacement triggering event, based on a result of the monitoring;
receiving user data for the user associated with the at least one of audio data or history data;
identifying object-related information, the object-related information comprising at least one of object protection information or object replacement information; and
transmitting the at least one of object protection information or object replacement information based on identifying the object-related information.

12. The computer-implemented method of claim 11, wherein the input replacement coverage information comprises images or text and is stored at a replacement server database, the replacement server database comprising other input replacement coverage information from one or more other users.

13. The computer-implemented method of claim 12, further comprising:
accessing the replacement server database to determine the object-related information, the object-related information further comprising object maintenance, repair services, replacement reduction, or object disposal, sale or contribution information.

14. The computer-implemented method of claim 11, wherein transmitting the object protection information includes an interactive agent for providing the user with responsive coverage information.

15. The computer-implemented method of claim 11, wherein the user data includes registered protection information input by the user, or operation data from an operation database.

16. The computer-implemented method of claim 11, further comprising:
receiving updated object protection data; and
providing a real-time notification to the user related to the updated object protection data.

17. The computer-implemented method of claim 11, wherein identifying the object corresponding to the object replacement triggering event is performed using a machine-learning model, the machine-learning model trained by correlating other audio data or other history data associated with other object protection data to determine trends for identifying an object in need of replacement.

18. The computer-implemented method of claim 11, the monitoring is performed based on receiving an opt-in indication from the user.

19. The computer-implemented method of claim 11, further comprising:
receiving other user data from one or more other users, and
identifying the object replacement information based on the other user data from the one or more other users.

20. A system for providing an object protection indicator, the system comprising:
monitoring, using a processor, at least one of audio data or history data associated with a user;
detecting an object replacement triggering event, based on a result of the monitoring;
receiving user data for a user associated with the at least one of audio data or history data;
identifying an object corresponding to the object replacement triggering event based on the user data;
identifying object-related information, the object-related information comprising at least one of object protection information or object replacement information; and
transmitting the at least one of object protection information or object replacement information based on identifying the object-related information.
